(19) United States
(12) Patent Application Publication
(10) Pub. No.: US 2025/0068965 A1
(43) Pub. Date: Feb. 27, 2025

(54) DATA-PRIVACY-PRESERVING SYNTHESIS OF REALISTIC SEMI-STRUCTURED TABULAR DATA

(71) Applicant: SAP SE, Walldorf (DE)

(72) Inventors: Matthias Frank, Heidelberg (DE); Sundeep Gullapudi, Singapore (SG); Rajesh Vellore Arumugam, Singapore (SG); Anantharaman Ravi, Singapore (SG); Prawira Putra Fadjar, Singapore (SG); Yi Quan Zhou, Singapore (SG)

(21) Appl. No.: 18/455,775

(22) Filed: Aug. 25, 2023

(51) Int. Cl. G06N 20/00; G06F 16/22

(52) U.S. Cl. CPC G06N 20/00; G06F 16/2282

(57) ABSTRACT

Methods, systems, and computer-readable storage media for receiving a real data table, providing a synthetic structured table based on the real data table, providing a sampled data table comprising a sub-set of real data of the real data table, transmitting a prompt to a LLM system, the prompt being generated based on the real data table and the synthetic structured data table, receiving synthetic unstructured data from the LLM system, providing an aggregate synthetic table that includes at least a portion of the synthetic unstructured data, and training a ML model using the aggregate synthetic table.

### BACKGROUND

Enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using machine learning (ML) systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

### SUMMARY

Implementations of the present disclosure are directed to a machine learning (ML) system for training one or more ML models using synthetic data. More particularly, implementations of the present disclosure are directed to using large language models (LLMs) to generate realistic, synthetic semi-structured tabular data that preserves data privacy in training ML models.

In some implementations, actions include receiving a real data table, providing a synthetic structured table based on the real data table, providing a sampled data table comprising a sub-set of real data of the real data table, transmitting a prompt to a LLM system, the prompt being generated based on the real data table and the synthetic structured data table, receiving synthetic unstructured data from the LLM system, providing an aggregate synthetic table that includes at least a portion of the synthetic unstructured data, and training a ML model using the aggregate synthetic table. Other implementations of this aspect include corresponding systems, apparatus, and computer programs, configured to perform the actions of the methods, encoded on computer storage devices.

These and other implementations can each optionally include one or more of the following features: the prompt includes rows of the sampled data table as few-shot examples for a LLM of the LLM system to generate the synthetic unstructured data; the prompt is generated using a prompt template; the sampled data table is provided by sampling rows of the real data table; providing an aggregate synthetic table includes selectively filtering at least a portion of a semi-structured synthetic table that is provided from the LLM system; providing an aggregate synthetic table includes aggregating at least portions of multiple semi-structured synthetic table; and the synthetic structured table includes synthetic structured data that is generated based on one or more distributions determined from the real data table.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts portions of example electronic documents.

FIG. 4 depicts an example conceptual architecture in accordance with implementations of the present disclosure.

FIGS. 5A and 5B depict example tables in accordance with implementations of the present disclosure.

FIG. 6 depicts an example process that can be executed in accordance with implementations of the present disclosure.

FIG. 7 is a schematic illustration of example computer systems that can be used to execute implementations of the present disclosure.

Like reference symbols in the various drawings indicate like elements.

### DETAILED DESCRIPTION

Implementations of the present disclosure are directed to a machine learning (ML) system for training one or more ML models using synthetic data. More particularly, implementations of the present disclosure are directed to using large language models (LLMs) to generate realistic, synthetic semi-structured tabular data that preserves data privacy in training ML models.

Implementations can include actions of receiving a real data table, providing a synthetic structured table based on the real data table, providing a sampled data table comprising a sub-set of real data of the real data table, transmitting a prompt to a LLM system, the prompt being generated based on the real data table and the synthetic structured data table, receiving synthetic unstructured data from the LLM system, providing an aggregate synthetic table that includes at least a portion of the synthetic unstructured data, and training a ML model using the aggregate synthetic table.

Implementations of the present disclosure are described in further detail herein with reference to an example problems space of matching entities represented by computer-readable records (electronic documents). It is contemplated, however, that implementations of the present disclosure can be realized in any appropriate problem space.

Matching entities represented by computer-readable records appears in many contexts. Example contexts can include matching product catalogs, deduplicating a materials database, and matching incoming payments from a bank statement table to open invoices. Implementations of the present disclosure are described in further detail with reference to an example use case within the example problem space, the example use case including the domain of finance and matching bank statements to invoices. More particularly, implementations of the present disclosure are described with reference to the problem of, given a bank statement (e.g., a computer-readable electronic document recording data representative of a bank statement), enabling an autonomous system using a ML model to determine one or more invoices (e.g., computer-readable electronic documents recording data representative of one or more invoices) that are represented in the bank statement. It is contemplated, however, that implementations of the present disclosure can be realized in any appropriate use case within the example problem space.

To provide context for implementations of the present disclosure, and as introduced above, enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using ML systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statement line items to invoices, and bank statement line items to customer accounts.

Technologies related to ML have been widely applied in various fields. For example, ML-based decision systems can be used to make decisions on subsequent tasks. With reference to the example use case, an ML-based decision system can be used to determine matches between bank statement line items and invoices. For example, invoices can be cleared in an accounting system by matching invoices to one or more line items in bank statements. In general, an output of a ML-based decision system can be referred to as a prediction or an inference result.

In data-centric enterprise applications, there often is a need for substantially sized, realistic datasets to be used as training data (which also can be used as testing data and validation data) for ML models, and also more broadly for developing and testing of applications. The performance (functional or computational) of applications that use ML models depends on the characteristics of the training data. Depending on the use case, actual data may be extremely hard or expensive to collect, such that the size and representativeness of datasets available for training ML models or during development is limited. For example, a dataset collected from an existing product will represent the product's main market (e.g., region, customer demographic). However, for expanding the product's scope, it may be desirable to have data that also covers different segments. Further, data may have restrictions as to when and where and for which purposes it can be stored and processed (e.g., some data may only exist on production infrastructure but not be exported to development or ML training infrastructure for security and data protection reasons).

When some data is available, but not in the needed volume, representativeness, or under circumstances that enable the desired use, suitable data can be synthesized, using the real data to inform the synthesis. For perfectly structured data (e.g., tabular data, where each field has a clear data type and format), creation of realistic synthetic data can be straight-forward. For example, synthetic data can be generated using distributional statistics (e.g., means, correlations, higher-order moments of the distributions) from the real data and drawing new samples from these distributions. However, some use cases include semi-structured data (e.g., tabular data that includes unstructured fields, such as free-text fields whose format and content is not pre-defined).

Examples for such free-text fields that occur as part of tabular data can include, without limitation, user input or message, a payment note in a bank statement, a line in a log from some computer system, OCR-extracted text from an attachment image, and the like. For semi-structured data, sampling schemes, such as sampling from distributions, are not successful, because it is often precisely the difficult to extract and model as distributions correlations of unstructured fields with structured fields that make the data realistic and useful. For example, a user's feedback might depend on a structured field that encodes the time it took to complete their request, or a bank statement payment note might mention some reference numbers encoded in structured fields.

Further, using real-world data for training ML models and/or developing applications that leverage ML models can have data privacy implications. Consequently, synthetic data that is generated from real-word data should account for data privacy to avoid leakage of private data.

In view of the above context, implementations of the present disclosure are directed to using LLMs to generate realistic, synthetic semi-structured tabular data that preserves data privacy in training ML models. More particularly, and as described in further detail herein, implementations of the present disclosure provide a data synthesis system that uses a hybrid data synthesis approach. The hybrid data synthesis approach uses traditional methods to synthesize data for structured fields and few-shot inference of a LLM to synthesize data for unstructured fields in a semi-structured table (e.g., a table including one or more structured fields and one or more unstructured fields).

Implementations of the present disclosure are described in further detail herein with reference to an example application that leverages one or more ML models to provide functionality (referred to herein as a ML application). The example application includes SAP Cash Application (CashApp) provided by SAP SE of Walldorf, Germany. CashApp leverages ML models that are trained using a ML framework (e.g., SAP AI Core) to learn accounting activities and to capture rich detail of customer and country-specific behavior.

An example accounting activity can include matching payments indicated in a bank statement to invoices for clearing of the invoices. For example, using an enterprise system (e.g., SAP S/4 HANA), incoming payment information (e.g., recorded in computer-readable bank statements) and open invoice information are passed to a matching engine, and, during inference, one or more ML models predict matches between line items of a bank statement and invoices. In some examples, matched invoices are either automatically cleared (auto-clearing) or suggested for review by a user (e.g., accounts receivable). Although CashApp is referred to herein for purposes of illustrating implementations of the present disclosure, it is contemplated that implementations of the present disclosure can be realized with any appropriate application that leverages one or more ML models.

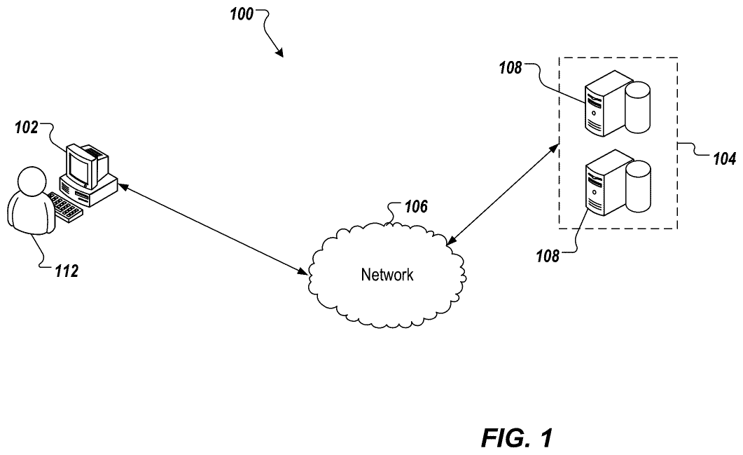

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a ML-based decision system that predicts matches between entities (e.g., CashApp, referenced by way of example herein). Also in accordance with implementations of the present disclosure, the server system 104 can host a ML model training system that includes a data synthesis system that uses a hybrid data synthesis approach to generate synthetic data for semi-structured tables.

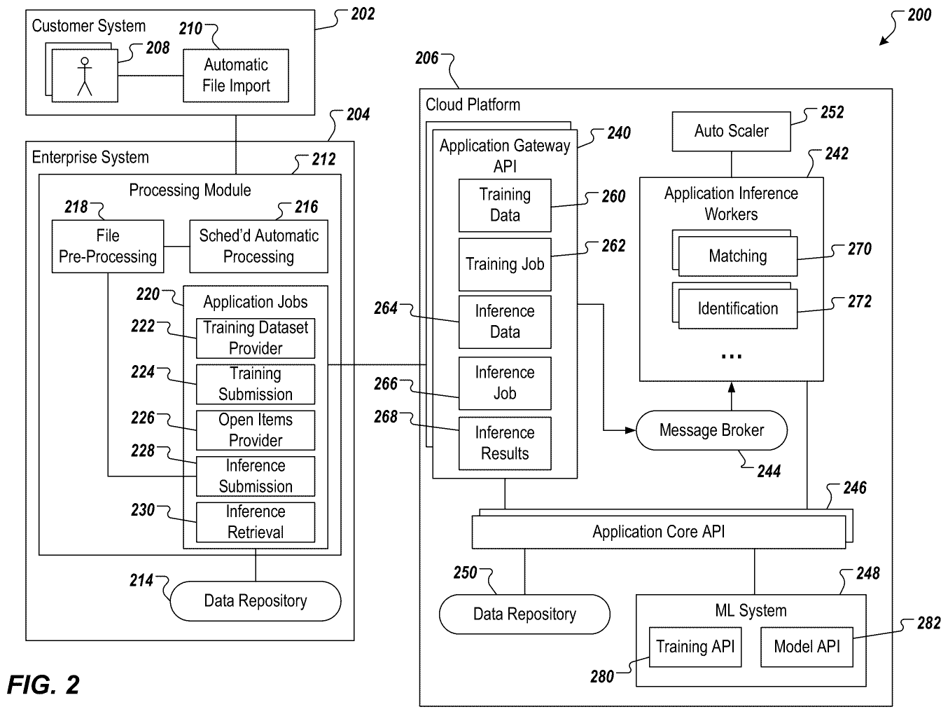

FIG. 2 depicts an example conceptual architecture 200 in accordance with implementations of the present disclosure. In the depicted example, the conceptual architecture 200 includes a customer system 202, an enterprise system 204 (e.g., SAP S/4 HANA) and a cloud platform 206 (e.g., SAP Cloud Platform (Cloud Foundry)). As described in further detail herein, the enterprise system 204 and the cloud platform 206 facilitate one or more ML applications that leverage ML models to provide functionality for one or more enterprises. In some examples, each enterprise interacts with the ML application(s) through a respective customer system 202. For purposes of illustration, and without limitation, the conceptual architecture 200 is discussed in further detail with reference to CashApp, introduced above. However, implementations of the present disclosure can be realized with any appropriate ML application.

In the example of FIG. 2, the customer system 202 includes one or more client devices 208 and a file import module 210. In some examples, a user (e.g., an employee of the customer) interacts with a client device 208 to import one or more data files to the enterprise system 204 for processing by a ML application. For example, and in the context of CashApp, an invoice data file and a bank statement data file can be imported to the enterprise system 204 from the customer system 202. In some examples, the invoice data file includes data representative of one or more invoices issued by the customer, and the bank statement data file includes data representative of one or more payments received by the customer. As another example, the one or more data files can include training data files that provide customer-specific training data for training of one or more ML models for the customer.

In the example of FIG. 2, the enterprise system 204 includes a processing module 212 and a data repository 214. In the context of CashApp, the processing module 212 can include a finance—accounts receivable module. The processing module 212 includes a scheduled automatic processing module 216, a file pre-processing module 218, and an applications job module 220. In some examples, the scheduled automatic processing module 216 receives data files from the customer system 202 and schedules the data files for processing in one or more application jobs. The data files are pre-processed by the file pre-processing module 218 for consumption by the processing module 212.

Example application jobs can include, without limitation, training jobs and inference jobs. In some examples, a training job includes training of a ML model using a training file (e.g., that records customer-specific training data). In some examples, an inference job includes using a ML model to provide a prediction, also referred to herein as an inference result. In the context of CashApp, the training data can include invoice to bank statement line item matches as examples provided by a customer, which training data is used to train a ML model to predict invoice to bank statement matches. Also in the context of CashApp, the data files can include an invoice data file and a bank statement data file that are ingested by a ML model to predict matches between invoices and bank statements in an inference process.

With continued reference to FIG. 2, the application jobs module 220 includes a training dataset provider sub-module 222, a training submission sub-module 224, an open items provider sub-module 226, an inference submission sub-module 228, and an inference retrieval sub-module 230. In some examples, for a training job, the training dataset provider sub-module 222 and the training submission sub-module 224 function to request a training job from and provide training data to the cloud platform 206. In some examples, for an inference job, the training dataset provider sub-module 222 and the training submission sub-module 224 function to request a training job from and provide training data to the cloud platform 206.

In some implementations, the cloud platform 206 hosts at least a portion of the ML application (e.g., CashApp) to execute one or more jobs (e.g., training job, inference job). In the example of FIG. 2, the cloud platform 206 includes one or more application gateway application programming interfaces (APIs) 240, application inference workers 242 (e.g., matching worker 270, identification worker 272), a message broker 244, one or more application core APIs 246, a ML system 248, a data repository 250, and an auto-scaler 252. In some examples, the application gateway API 240 receives job requests from and provides job results to the enterprise system 204 (e.g., over a REST/HTTP [oAuth] connection). For example, the application gateway API 240 can receive training data 260 for a training job 262 that is executed by the ML system 248. As another example, the application gateway API 240 can receive inference data 264 (e.g., invoice data, bank statement data) for an inference job 266 that is executed by the application inference workers 242, which provide inference results 268 (e.g., predictions).

In some examples, the enterprise system 204 can request the training job 262 to train one or more ML models using the training data 260. In response, the application gateway API 240 sends a training request to the ML system 248 through the application core API 246. By way of non-limiting example, the ML system 248 can be provided as SAP AI Core. In the depicted example, the ML system 248 includes a training API 280 and a model API 282. The ML system 248 trains a ML model using the training data. In some examples, the ML model is accessible for inference jobs through the model API 282.

In some examples, the enterprise system 204 can request the inference job 266 to provide the inference results 268, which includes a set of predictions from one or more ML models. In some examples, the application gateway API 240 sends an inference request, including the inference data 264, to the application inference workers 242 through the message broker 244. An appropriate inference worker of the application inference workers 242 handles the inference request. In the example context of matching invoices to bank statements, the matching worker 270 transmits an inference request to the ML system 248 through the application core API 246. The ML system 248 accesses the appropriate ML model (e.g., the ML model that is specific to the customer and that is used for matching invoices to bank statements), which generates the set of predictions. The set of predictions are provided back to the inference worker (e.g., the matching worker 270) and are provided back to the enterprise system 204 through the application gateway API 240 as the inference results 266. In some examples, the auto-scaler 252 functions to scale the inference workers up/down depending on the number of inference jobs submitted to the cloud platform 206.

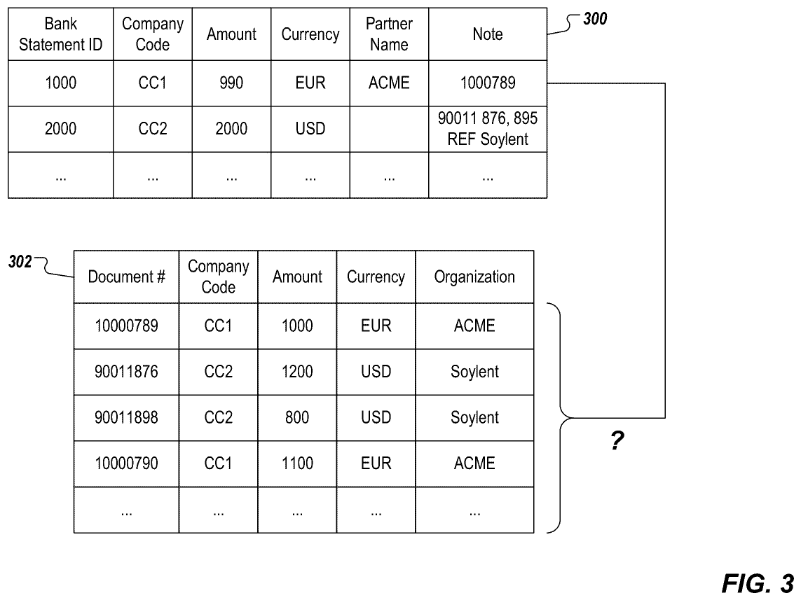

In the example context, FIG. 3 depicts portions of example electronic documents. In the example of FIG. 3, a first electronic document 300 includes a bank statement table that includes records representing payments received, and a second electronic document 302 includes an invoice table that includes invoice records respectively representing invoices that had been issued. In the example context, each bank statement record is to be matched to one or more invoice records. Accordingly, the first electronic document 300 and the second electronic document 302 are processed using one or more ML models that provide predictions regarding matches between a bank statement record (entity) and one or more invoice records (entity/-ies) (e.g., using CashApp, as described above).

To achieve this, a ML model (matching model) is provided as a classifier that is trained to predict entity pairs to a fixed set of class labels (\vec{l}) (e.g., l₀, l₁, l₂). For example, the set of class labels (\vec{l}) can include ‘no match’ (l₀), ‘single match’ (l₁), and ‘multi match’ (l₂). In some examples, the ML model is provided as a function ƒ that maps a query entity (\vec{a}) and a target entity (\vec{b}) into a vector of probabilities (\vec{p}) (also called ‘confidences’ in the deep learning context) for the labels in the set of class labels. This can be represented as:

$$f ( \vec{a} , \vec{b} ) = ( \begin{matrix}{p}_{0} \\ {p}_{1} \\ {p}_{2}\end{matrix} )$$

where \vec{p}={p₀, p₁, p₂}. In some examples, p₀ is a prediction probability (also referred to herein as confidence c) of the item pair \vec{a}, \vec{b} belonging to a first class (e.g., no match), p₁ is a prediction probability of the item pair \vec{a}, \vec{b} belonging to a second class (e.g., single match), and p₂ is a prediction probability of the item pair \vec{a}, \vec{b} belonging to a third class (e.g., multi match).

Here, p₀, p₁, and p₂ can be provided as numerical values indicating a likelihood (confidence) that the item pair \vec{a}, \vec{b} belongs to a respective class. In some examples, the ML model can assign a class to the item pair \vec{a}, \vec{b} based on the values of p₀, p₁, and p₂. In some examples, the ML model can assign the class corresponding to the highest value of p₀, p₁, and p₂. For example, for an entity pair \vec{a}, \vec{b}, the ML model can provide that p₀=0.13, p₁=0.98, and p₂=0.07. Consequently, the ML model can assign the class ‘single match’ (l₁) to the item pair \vec{a}, \vec{b}.

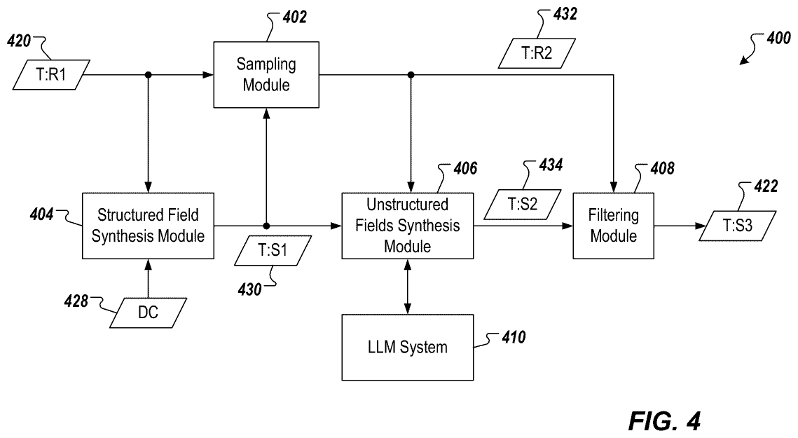

FIG. 4 depicts an example conceptual architecture 400 in accordance with implementations of the present disclosure. In the example of FIG. 4, the conceptual architecture 400 includes a sampling module 402, a structured field synthesis module 404, an unstructured field synthesis module 406, a filtering module 408, and a LLM system 410. As described in further detail herein, a table 420 is processed through the conceptual architecture 400 to provide a table 422. The table 420 is provided as a computer-readable file that records real-world data. For example, the table 420 can include historical bank statement and/or invoice data of one or more real-world enterprises. The table 420 is provided as a computer-readable file that records synthetic data that is generated by the conceptual architecture 400 using the table 420. For example, the table 422 can include fictional bank statement and/or invoice data of one or more fictional enterprises.

In further detail, the table 420 includes one or more structured fields (s₁, . . . , sₙ) and one or more unstructured (e.g., free text) fields (u₁, . . . , uₘ). In some examples, the structured field synthesis module 404 determines the schema of the table 420, as well as distribution statistics on data recorded in the structured field(s) (e.g. ranges, means, distribution moments of numerical values), formatting and ranges of reference numbers; correlations among features (e.g., when the data contains date fields, the difference of dates is often more informative than the individual dates). In some examples, the schema indicates fields that contain structured data and fields that contain unstructured data.

In some examples, the schema may be available as meta information from the table definition (e.g., some fields may be clearly typed as “date” with a specific format, such as “YYYYMMDD,” or as “amount,” with an associated “currency” field). In some examples, the schema may be algorithmically estimated from the data by, for example, successively attempting to parse all values contained in a field as different types until it can be parsed successfully. For example, the algorithm can first attempt to parse all values as “date” of various formats; if this attempt fails, it can proceed to parse the values as “numeric” types (integer or floating point); if this attempt fails, it can parse the values as “text”, that is, unstructured data. The aggregate statistics collected for the structured fields may depend on the data type; for example, for dates, the aggregate statistics may simply be the minimum and maximum date; for numeric fields, additionally the mean and standard deviation of the distribution may be collected.

The schema information and aggregate statistics are used to randomly sample the data recorded in the structured field(s) (s₁, . . . , sₙ) of one or more rows so that the sampled data are compatible with the schema information and aggregate statistics, and the sampled data generate synthetic structured data, which is recorded in a table 430. For example, date entries can be randomly sampled from a uniform distribution bounded by the minimum and maximum dates and formatted in the same way as indicated by the schema (e.g., in “YYYYMMDD” format); numeric data can be sampled from, for example, a truncated normal distribution, with a mean and standard deviation equal to those collected as aggregate statistics and truncated to the aggregated minimum and maximum values.

In some examples, the synthetic structured data is generated by determining a best-fit distribution for the data recorded in each of the one or more structured fields of the table 420 and using the distribution parameters of the best-fit distribution to generate synthetic data for a respective structured field. That is, a distribution can be determined for each structured field and synthetic data can be determined for a structured field using the distribution for that structured field. For example, for a categorical field, the frequency of each value may be collected as aggregate information. For sampling synthetic data, a multinomial distribution may be initialized from these aggregated frequencies, such that, when sampling from this distribution, the relative frequencies of, for example, different country codes will be similar (or identical in the theoretical limit of sampling an infinite amount of data) to those in the real data. More complex, hierarchical models can be used to capture correlations. For example, a multinomial distribution can be used to model a categorical “currency” field, and truncated normal distributions can be used to model “amounts,” whereby the mean and standard deviations of these depend on the value taken by “currency.” to reflect that exchange rates and regional economics may drive the typical amount ranges occurring with different currencies. The use of aggregate information helps to ensure that no individual example of the real data (e.g., potentially protected or private information) is leaked into the synthetic data that is recorded in the table 430.

In some examples, distribution constraints (DCs) 428 can be imposed in generation of the synthetic data. For example, the real data might under-represent some part of the distribution (e.g., a country code), but the synthetic data might be desired to have a uniform distribution (e.g., across several county codes).

In some examples, the synthetic data can be generated independently of the real data recorded in the table 420. For example, an off-the-shelf tool can be used to generate synthetic data based on the schema and semantics of the real data recorded in the table 420 without relying on the distribution of the real data recorded in the table 420. An example off-the-shelf tool includes, without limitation, Faker published by Daniele Faraglia.

In some implementations, the sampling module 402 samples rows of real data from the table 420 and records the sample rows in a table 432. As such, the real data recorded in the table 432 includes a sub-set of the real data recorded in the table 420. In some examples, the real data can be randomly sampled from the table 420. In some examples, a number of rows sampled from the table 420 is limited (e.g., only 3-5 rows are sampled). Limiting the number of rows that are sampled has multiple practical purposes. For example, and as described in further detail herein, actual data in the table 432 is used as prompts to a LLM of the LLM system 410. Because the context window of LLMs is limited, only a small number of examples can fit into the prompt that is input to the LLM. As another example, checking against information leaks from the real data to the synthetic data, described in further detail herein, is simplified (computationally) by limiting the number of rows that are sampled.

In some examples, the real data that is sample can depend on the synthetic data recorded in the table 430. For example, it can be preferrable to select rows from the table 420 that are similar to values of synthetic structured data recorded in the table 420. For example, each row of synthetic structured data recorded in the table 430 can be compared to each real structured data of each row of the table 420 and respective similarity scores can be determined. For a row of synthetic structured data recorded in the table 430, the real unstructured data of the most-similar row (e.g., highest similarity score) is selected from the table 420 for inclusion in the table 432. In determining similarity, any appropriate similarity measure can be used. For example, and without limitation, a real vector can be provided as values of real data from a row of the table 420 and a synthetic vector can be provided as values of synthetic data from a row of the table 430. The real vector can be compared to the synthetic vector and a similarity score can be provided (e.g., cosine similarity).

In accordance with implementations of the present disclosure, the table 430 and the table 432 are provided to the unstructured fields synthesis module 406, which interacts with the LLM system 410 to provide a table 434. As described in further detail herein, the table 434 records synthetic structured data from the table 430 and synthetic unstructured data determined from the LLM system 410 by using the real unstructured data of the table 432 as prompts to the LLM system 410.

In further detail, the LLM system 410 can execute a LLM that receives prompts and generates content that is responsive to the prompts. In some examples, the LLM system 410 is provided as a third-party system that receives prompts through application programming interface (API) calls. Example LLMs can include, but are not limited to BLOOM, published by Hugging Face, GPT4, published by OpenAI, and StarCoder, published by Hugging Face. The LLM is prompted to complete the unstructured fields of rows of the table 430 using real unstructured data of the table 432 as examples. The exact format of the input prompt depends on the specific LLM executed by the LLM system 410 and may differ depending on whether the LLM was pretrained only on a completion objective, or pre-trained to follow natural-language instructions, as illustrated below.

In further detail, the content of the table 432 and the table 430 is fed to the LLM as a context, and the output of the LLM contains synthetic data (e.g., LLM-generated data). A table 434 is provided, which includes synthetic structured data from the structured fields of the table 430 and synthetic unstructured data provided as the output of the LLM. In some examples, providing the context with the prompt can be referred to as few-shot learning. In natural language processing (NLP), few-shot learning (also referred to as in-context learning and/or few-shot prompting) is a prompting technique that enables a LLM to process examples before attempting a task. In the context of the present disclosure, the task includes providing synthetic unstructured data. Few-shot learning is distinct from fine-tuning of a LLM, which is pre-trained, on a task-specific dataset. More particularly, during few-shot learning, no parameters of the LLM are changed. Instead, the few-shot examples input to the LLM prime the LLM to provide context for subsequent queries submitted to the LLM.

To ensure no sensitive information (e.g., private information, protected information) is leaked into the synthetic data of the table 434, the filtering module 408 selectively filters rows from the table 434 to provide the table 422. More particularly, the filtering module compares the synthetic unstructured data in the unstructured fields u₁, . . . , uₘ of the table 434 to the real unstructured data in the unstructured fields u₁, . . . , uₘ of the table 432. In some examples, if any of the real unstructured data is determined to be sufficiently similar to synthetic unstructured data, the row containing the synthetic unstructured data is deleted from the table 434. This filtering process, if any, results in the table 422. In some examples, any appropriate similarity measure can be used. For example, and without limitation, a real vector can be provided as values of real unstructured data from a row of the table 432 and a synthetic vector can be provided as values of synthetic unstructured data from a row of the table 434. The real vector can be compared to the synthetic vector and a similarity score can be provided (e.g., cosine similarity). If the similarity score meets or surpasses a threshold value, the real unstructured data is determined to be sufficiently similar to synthetic unstructured data, the row containing the synthetic unstructured data is deleted from the table 434.

As noted above, the table 432 includes a limited number of rows. Consequently, filtering can be chosen almost arbitrarily strict and conservative (to ensure no protected information flows from the table 432 to the table 434), as long as some (possibly small) fraction of rows pass through the filter. For example, a combination of a semantic similarity criterion, in combination with a hard cut on the maximum allowed length of common character sequences can be used. This stands in contrast to a comparison against an entire larger dataset, such as represented in the table 420, which would necessarily need to rely on more fuzzy, statistical criteria for comparison, or else almost always filter out all generated synthetic unstructured data.

In some implementations, the process through the architecture 400 is repeated multiple times to provide multiple tables 434. The multiple tables 434 are aggregated into an aggregate synthetic table (dataset). In some examples, the process and aggregation repeat until the aggregate synthetic table reaches a desired size and/or any other appropriate stop criterion is reached (e.g., a fixed computational budget is reached).

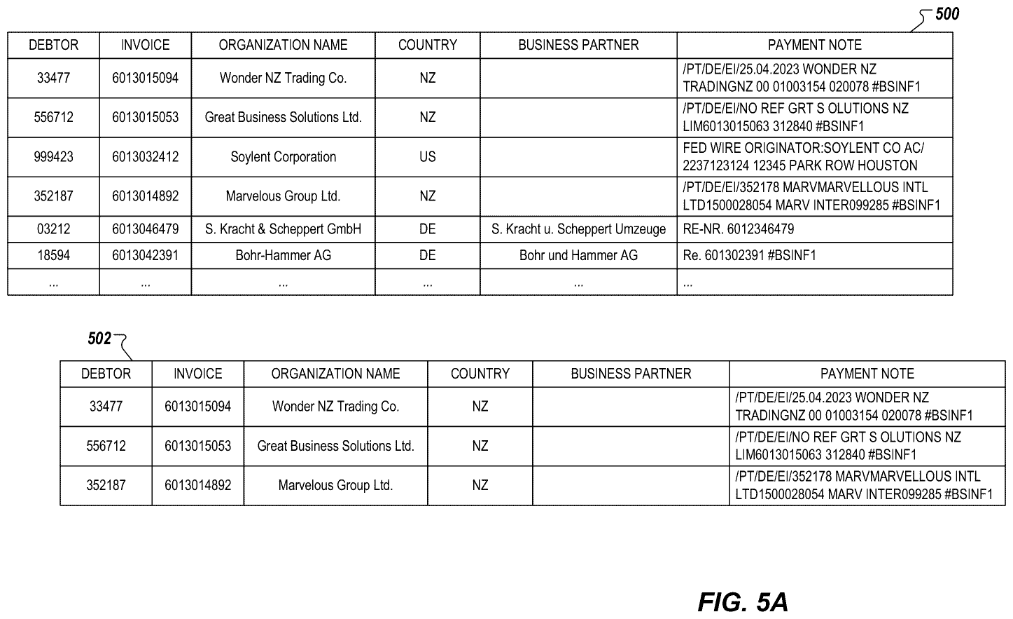

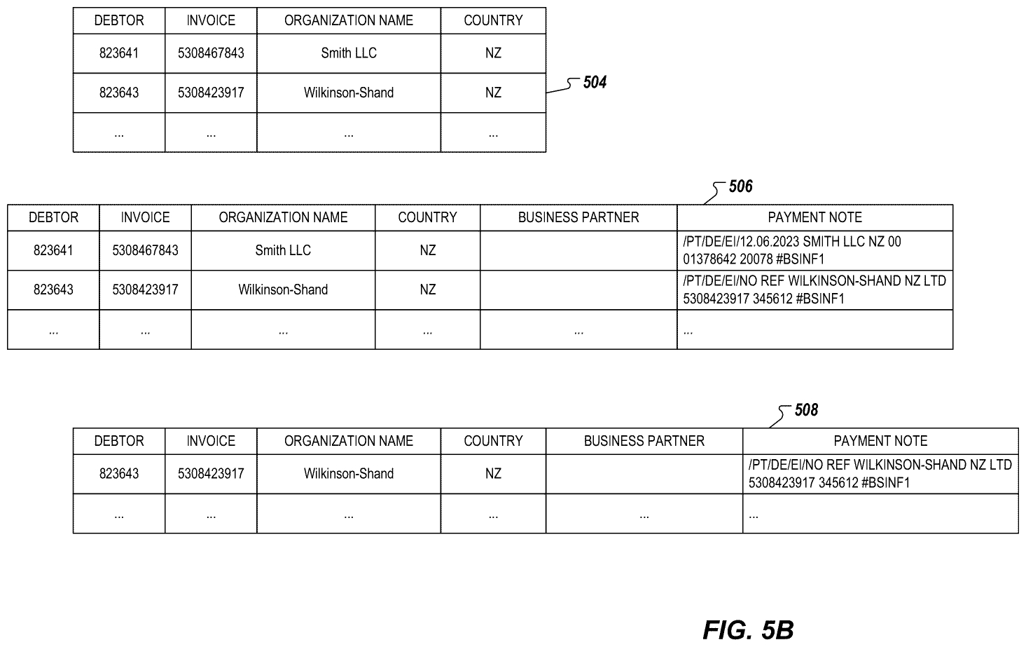

FIGS. 5A and 5B depict example tables 500, 502, 504, 506, 508 in accordance with implementations of the present disclosure. The example depicted in FIGS. 5A and 5B represent generation of synthetic data that can be used to train ML models for matching open invoices (or invoice line items) to bank statement line items/incoming bank payments. The table 500 depicts real data including structured fields and unstructured fields. For example, the table 500 represents the table 420 of FIG. 4.

In the example, the table 500 records existing real data that includes already matched invoices and bank statement fields. However, in matching, the existing real data usually come from different tables. That is, instead of a single table such as the table 500, a table of invoice line items, a table of bank statement line items, and a relation table (to link which payment refers to which invoice line item) are provided. For purposes of non-limiting illustration, the table 500 represents these data as one table, whose rows include fields of an invoice line item and the fields of a matching bank statement line item. After generating the synthetic data, the resulting table (e.g., the aggregate synthetic table) can be split into a bank statement table, an invoice table, and a relation table for training a ML model.

Referring again to FIG. 5A, from the schema of the of the table 500, the invoice fields DEBTOR (an integer account number with 5-6 digits, sometimes 0-padded), INVOICE (a 10-digit reference number), and COUNTRY (a categorical with a set of COUNTRY codes) are identified as structured data that can be synthesized by sampling random numbers and formatting them accordingly or sampling COUNTRY codes from a list. The field ORGANIZATION NAME is a text-field with clear semantics (a company name) that can be synthesized, as discussed herein. The table 504 of FIG. 5B depicts example synthetic structured data that can be generated based on the real structured data of the table 500 of FIG. 5A.

Referring again to the table 500, the fields BUSINESSPARTNER (that in some contexts/countries carries the company name, but potentially with some variations) and PAYMENT NOTE are identified as unstructured data and are used to generate synthetic unstructured data using a LLM, as described herein. In accordance with implementations of the present disclosure, a sub-set of rows of the table 500 can be sampled to provide the table 502 of FIG. 5A. The table 502 corresponds to the table 432 of FIG. 4. In this example, the rows that include the same country codes as included in the table 504 are sampled (e.g., country code NZ). As such, the table 504 can be provided after the table 502.

As described herein, LLM inference is used to generate the synthetic unstructured data for the fields BUSINESSPARTNER and PAYMENT NOTE to yield the table 506 of FIG. 5B. That is, content of the table 502 can be used to provide a prompt that includes few-shot examples to the LLM and an instruction to complete the remaining rows. An example prompt can be provided as:

```
    DEBTOR;INVOICE;ORGANIZATIONNAME;TRANSACTIONCURRENCYiv;BUSIN
      ESSPARTNERNAME;MEMOLINE
    33477;6013015094;Wonder New Zealand Trading Co;NZ;;/PT/DE/
      EI/25.04.2023 WONDER NZ TRADINGNZ 00 01003154 020078
      #BSINF1
    556712;6013015053; Great Business Solutions Ltd;NZ; /PT/DE
      /EI/NO REF GRT S OLUTIONS NZ LIM6013015063 312840 #BSINF1
    352187;6013014892; Marvelous Group Ltd;NZ; /PT/DE/EI/352178
      MARVMARVELLOUS INTL LTD1500028054 MARV INTER099285
      #BSINF1
Given the above table, complete the following rows by generating
  similar contents for the missing fields
    823641;5308467843;Smith LLC;NZ;;
    823643;5308423917; Wilkinson-Shand;NZ;;
```

In the example above, the table data preceding the query (i.e., “Given the above . . . ), serve as few-shot learning examples that prime the LLM to provide the output. In some examples, the prompt can be generated using a prompt template. An example prompt template can include:

```
  [SAMPLED TABLE]
Given the above table, complete the following rows by generating
similar contents for the missing fields
  [SYNTHETIC STRUCTURED TABLE]
```

Example output of the LLM from the above example prompt can include:

```
823641;5308467843;Smith LLC;NZ;;/PT/DE/EI/12.06.2023 SMITH
  LLC NZ 00 01378642 20078 #BSINF1
823643;5308423917; Wilkinson-Shand;NZ;; /PT/DE/EI/NO REF
  WILKINSON-SHAND NZ LTD 5308423917 345612 #BSINF1
```

This is represented in the table 506 of FIG. 5B.

As described herein, any generated synthetic unstructured data that might contain elements leaked from the real data can be removed (e.g., by the filtering module 408 of FIG. 4). For example, each generated row of synthetic unstructured data (u=u₁, . . . , uₘ) can be compared to the full rows of the real data. In some examples, this can include removing stop-words from u to obtain u_{_without_stopwords}. In some examples, the stop-words are provided from a curated list of sequences common in the data that do not carry a relation to a particular instance, such as country codes [NZ, DE, US], bank-statement “meta” information [/PT/DE/EI/, NO REF, BSINF1], company suffixes [LTD, GMBH, LLC, AG], years [2023, 2022, 2021], and the like. It can be required that no sub-sequence of u_{_without_stopwords} longer than 3 characters is contained in any row of the real data.

In the example case of FIGS. 5A and 5B, there is an overlap of the sequence “20078” between the first rows of the table 506 and the table 502. Consequently, this row is filtered from the table 506 to provide the table 508 of FIG. 5B. In reality, the overlap of the sequence “20078” might not be any sort of data leakage. However, because the exact semantics of the data is not known (or is not needed to be known), a strict rejection criteria can be applied to be conservative.

As described above, the process of generating tables, such as the table 508 of FIG. 5B can be repeated, and the tables can be aggregated to provide an aggregate synthetic table that includes synthetic structured data and synthetic unstructured data. That is, the aggregate synthetic table is a semi-structured table. In some examples, the aggregate synthetic table can be split into multiple tables that can be used as training data for training a ML model. For example, and in the example context, the aggregate synthetic table can be split into a bank statement table, an invoice table, and a relation table that can be used as training data for training a ML model.

In accordance with implementations of the present disclosure, the aggregate synthetic table is used as training data to train a ML model. In some examples, a ML model can be iteratively trained using training data, such as the synthetic training data of the present disclosure, where, during an iteration, one or more parameters of the ML model are adjusted, and an output is generated based on the training data. For each iteration, a loss value is determined based on a loss function. The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

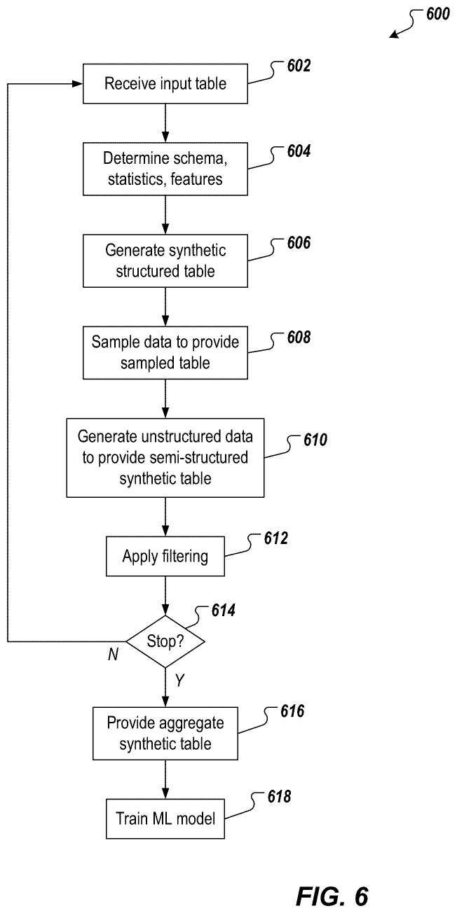

FIG. 6 depicts an example process 600 that can be executed in accordance with implementations of the present disclosure. In some examples, the example process 600 is provided using one or more computer-executable programs executed by one or more computing devices.

An input table is received (602). For example, and as described herein, the sampling module 402 and the structured field synthesis module 404 each received the table 420, which records real data (e.g., data that can include sensitive information). A schema, statistics, features, and the like are determined (604). For example, and as described herein, the structured field synthesis module 404 determines the schema (e.g., which fields record structured data, which fields record unstructured data) and statistics (e.g., distributions) associated with fields (e.g., structured fields). A synthetic structured table is generated (606). For example, and as described herein, synthetic structured data can be generated based on distributions determined for the structured fields and is recorded in the table 430.

Data of the input table is sampled to provide a sampled table (608). For example, and as described herein, the sampling module 402 samples real data (rows) of the table 420 to provide the table 432 (sampled table). In some examples, the rows are selected (sampled) based on the synthetic structured data. For example, real structured data of the table 420 can be compared to synthetic structured data of the table 430 to determine similarity therebetween, and the actual data (rows) can be selected based on similarity (e.g., rows having actual structured data that exceeds a threshold similarity to the synthetic structured data are selected for inclusion in the table 432).

Unstructured data is generated to provide a semi-structured synthetic table (610). For example, and as described herein, the unstructured fields synthesis module 406 provides a prompt to the LLM system 410, which returns output that includes synthetic unstructured data. The synthetic unstructured data is added to the table 430 to provide the table 434. Filtering is applied to the semi-structured synthetic table (612). For example, and as described herein, the filtering module 408 compares rows of the table 432 to rows of the table 434 and selectively removes rows of the table 434 based on the comparisons.

It is determined whether a stop condition has been met (614). For example, and as described herein, it can be determined whether a sufficient amount of synthetic data has been generated and/or whether a processing budget for generating synthetic data has been expended. If the stop condition has not been met, the example process 600 loops back to generate another semi-structured synthetic table. If the stop condition has been met, an aggregate synthetic table is provided (616) and a ML model is trained (618). For example, and as described herein, multiple tables 422 can be aggregated to provide an aggregate synthetic table, which can be used as training data to train a ML model.

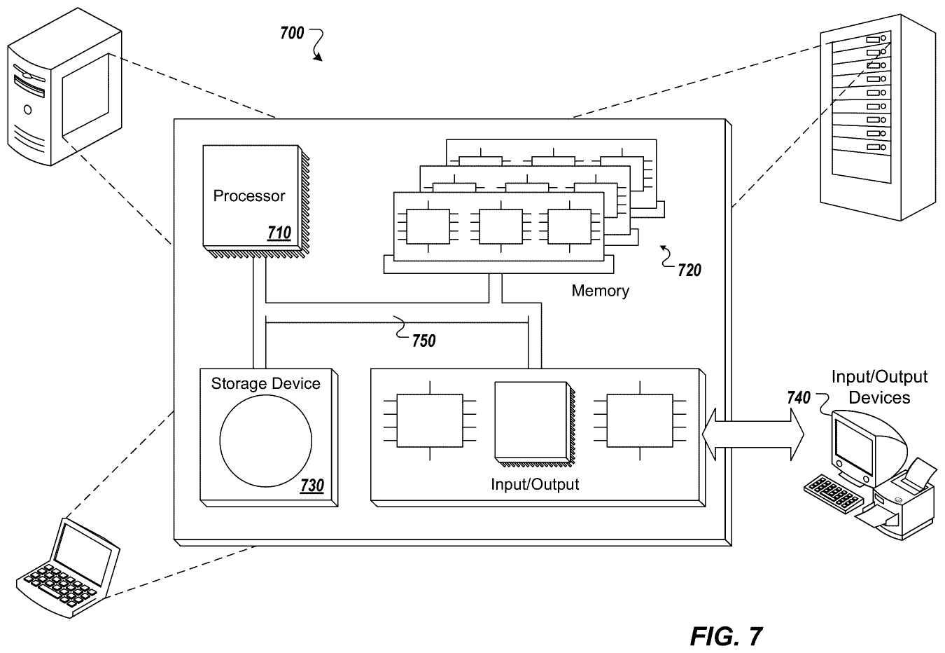

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for training one or more machine learning (ML) models, the method being executed by one or more processors and comprising:
receiving a real data table;
providing a synthetic structured table based on the real data table;
providing a sampled data table comprising a sub-set of real data of the real data table;
transmitting a prompt to a large language model (LLM) system, the prompt being generated based on the real data table and the synthetic structured data table;
receiving synthetic unstructured data from the LLM system;
providing an aggregate synthetic table that includes at least a portion of the synthetic unstructured data; and
training a ML model using the aggregate synthetic table.

2. The method of claim 1, wherein the prompt comprises rows of the sampled data table as few-shot examples for a LLM of the LLM system to generate the synthetic unstructured data.

3. The method of claim 1, wherein the prompt is generated using a prompt template.

4. The method of claim 1, wherein the sampled data table is provided by sampling rows of the real data table.

5. The method of claim 1, wherein providing an aggregate synthetic table comprises selectively filtering at least a portion of a semi-structured synthetic table that is provided from the LLM system.

6. The method of claim 1, wherein providing an aggregate synthetic table comprises aggregating at least portions of multiple semi-structured synthetic table.

7. The method of claim 1. wherein the synthetic structured table comprises synthetic structured data that is generated based on one or more distributions determined from the real data table.

8. A non-transitory computer-readable storage medium coupled to one or more processors and having instructions stored thereon which, when executed by the one or more processors, cause the one or more processors to perform operations for training one or more machine learning (ML) models, the operations comprising:
receiving a real data table;
providing a synthetic structured table based on the real data table;
providing a sampled data table comprising a sub-set of real data of the real data table;
transmitting a prompt to a large language model (LLM) system, the prompt being generated based on the real data table and the synthetic structured data table;
receiving synthetic unstructured data from the LLM system;
providing an aggregate synthetic table that includes at least a portion of the synthetic unstructured data; and
training a ML model using the aggregate synthetic table.

9. The non-transitory computer-readable storage medium of claim 8, wherein the prompt comprises rows of the sampled data table as few-shot examples for a LLM of the LLM system to generate the synthetic unstructured data.

10. The non-transitory computer-readable storage medium of claim 8, wherein the prompt is generated using a prompt template.

11. The non-transitory computer-readable storage medium of claim 8, wherein the sampled data table is provided by sampling rows of the real data table.

12. The non-transitory computer-readable storage medium of claim 8, wherein providing an aggregate synthetic table comprises selectively filtering at least a portion of a semi-structured synthetic table that is provided from the LLM system.

13. The non-transitory computer-readable storage medium of claim 8, wherein providing an aggregate synthetic table comprises aggregating at least portions of multiple semi-structured synthetic table.

14. The non-transitory computer-readable storage medium of claim 8, wherein the synthetic structured table comprises synthetic structured data that is generated based on one or more distributions determined from the real data table.

15. A system, comprising:
a computing device; and
a computer-readable storage device coupled to the computing device and having instructions stored thereon which, when executed by the computing device, cause the computing device to perform operations for training one or more machine learning (ML) models, the operations comprising:
receiving a real data table;
providing a synthetic structured table based on the real data table;
providing a sampled data table comprising a sub-set of real data of the real data table;
transmitting a prompt to a large language model (LLM) system, the prompt being generated based on the real data table and the synthetic structured data table;
receiving synthetic unstructured data from the LLM system;
providing an aggregate synthetic table that includes at least a portion of the synthetic unstructured data; and
training a ML model using the aggregate synthetic table.

16. The system of claim 15, wherein the prompt comprises rows of the sampled data table as few-shot examples for a LLM of the LLM system to generate the synthetic unstructured data.

17. The system of claim 15, wherein the prompt is generated using a prompt template.

18. The system of claim 15, wherein the sampled data table is provided by sampling rows of the real data table.

19. The system of claim 15, wherein providing an aggregate synthetic table comprises selectively filtering at least a portion of a semi-structured synthetic table that is provided from the LLM system.

20. The system of claim 15, wherein providing an aggregate synthetic table comprises aggregating at least portions of multiple semi-structured synthetic table.
